(19) United States
(12) Patent Application Publication
(10) Pub. No.: US 2016/0034191 A1
(43) Pub. Date: Feb. 4, 2016

(54) GRID ORIENTED DISTRIBUTED PARALLEL COMPUTING PLATFORM

(71) Applicant: KABUSHIKI KAISHA TOSHIBA, Tokyo (JP)

(72) Inventors: Atsuhiro KINOSHITA, Kamakura Kanagawa (JP); Johri RAM, San Jose, CA (US)

(21) Appl. No.: 14/811,665

(22) Filed: Jul. 28, 2015

Related U.S. Application Data
(60) Provisional application No. 62/032,469, filed on Aug. 1, 2014.

(51) Int. Cl. G06F 3/06

(52) U.S. Cl. CPC G06F 3/061; G06F 3/0688; G06F 3/0655; G06F 3/0635

(57) ABSTRACT

A distributed computing system includes a group of interconnected memory nodes, where one of the memory nodes is configured as a transaction ID manager. The transaction ID manager is configured to manage concurrency of database transactions by issuing a transaction ID for each database transaction performed in the system. In some embodiments, each memory node in the two-dimensional matrix is configured as a transaction ID manager. In such embodiments, the unique transaction IDs generated by the transaction ID manager at each memory node are transmitted with node-specific information, so that the unique transaction IDs generated at each memory node are distinguished from the unique transaction IDs generated by other memory nodes.

### CROSS-REFERENCE TO RELATED APPLICATION

This application is based upon and claims the benefit of priority from U.S. Provisional Patent Application No. 62/032,469, filed Aug. 1, 2014, the entire contents of which are incorporated herein by reference.

### BACKGROUND

As access to high-speed Internet becomes ubiquitous to most consumers, the use of distributed computing systems, in which multiple separate computers perform computation problems or information processing, is also becoming more widespread. In enterprise distributed computing systems, particularly enterprise data storage, banks or arrays of data storage devices and associated processors are commonly employed to facilitate large-scale data storage and access to such storage for a plurality of hosts or users. However, despite the extensive computational and data storage resources available in enterprise distributed computing systems, data sets stored by such systems are becoming so large and complex that data handling with acceptable latency is increasingly problematic. To wit, searching a TB-sized database to access a particular file can require many seconds or tens of seconds using conventional database management tools or traditional data processing applications. This is often because network latency within the distributed computing system, caused by network choke points, can dramatically slow system performance, even though processing by the individual elements of the distributed computing system is extremely fast. Consequently, implementing faster processors and/or storage devices in enterprise distributed computing systems results in little or no improvement in system performance.

### SUMMARY

One or more embodiments provide systems and methods for low-latency data processing in a distributed computing system. According to the embodiments, a distributed computing system includes a group of interconnected memory nodes, where at least one of the memory nodes is configured as a transaction ID manager. The transaction ID manager is configured to manage concurrency of input/output (IO) transactions by issuing a transaction ID for each JO transaction performed in the system. In some embodiments, each memory node in the two-dimensional matrix is configured as a transaction ID manager. In such embodiments, the transaction IDs generated by each memory node are transmitted with node-specific information. Consequently, the unique transaction IDs generated by the transaction ID manager at each memory node are distinguished from the unique transaction IDs generated by other memory nodes.

A memory system, according to embodiments, comprises a plurality of memory nodes interconnected with each other, and at least one connection server having an interface to a network switch and connected to the memory nodes. In at least one embodiment, each of the memory nodes includes a non-volatile memory device and a node controller configured to communicate with node controllers of other nodes, and the node controller of at least one of the memory nodes includes a transaction ID generator configured to generate a unique transaction ID in response to a request for a transaction ID received from the connection server.

Further embodiments provide a method of processing a read request at a target memory node of a data storage device that includes at least one connection server and a plurality of memory nodes, including the target memory node, interconnected with each other and connected to the at least one connection server. The method comprises the steps of receiving a read command from a connection server that includes a transaction ID, an ID of a memory node, and a memory address from which data is to be read, reading data stored at the memory address from the target memory node if an ID of the target memory node matches the ID of the memory node included in the read command and a transaction ID associated with data stored in the memory address is less than the transaction ID included in the read command, and transmitting from the target memory node to the connection server the data read from the memory address.

Further embodiments provide a method of processing a write request at a target memory node of a data storage device that includes at least one connection server and a plurality of memory nodes, including the target memory node, interconnected with each other and connected to the at least one connection server. The method comprises the steps of receiving a write command from a connection server that includes data to be written, a transaction ID, an ID of a memory node, and a memory address to which the data are to be written, and writing the data in the memory address if an ID of the target memory node matches the ID of the memory node included in the write command and a transaction ID associated with data most recently stored in the memory address is less than the transaction ID included in the write command.

### BRIEF DESCRIPTION OF THE DRAWINGS

FIG. 1 schematically illustrates a portion of a conventional distributed computing system.

FIG. 2 schematically illustrates a portion of a distributed computing system, configured according to one embodiment.

FIG. 3 schematically illustrates a memory node of a distributed computing system, according to an embodiment.

FIG. 4 schematically illustrates a distributed computing system, configured according to one embodiment.

FIGS. 5A-5I schematically illustrate the use at a memory node of TIDs in a multi-version concurrency control scheme that may be implemented in a distributed computing system, according to some embodiments.

FIG. 6 sets forth a flowchart of method steps for processing a read request carried out by a memory node when configured with the functionality of a TID manager, according to some embodiments.

FIG. 7 sets forth a flowchart of method steps for processing a write request carried out by a memory node when configured with the functionality of a TID manager, according to some embodiments.

### DETAILED DESCRIPTION

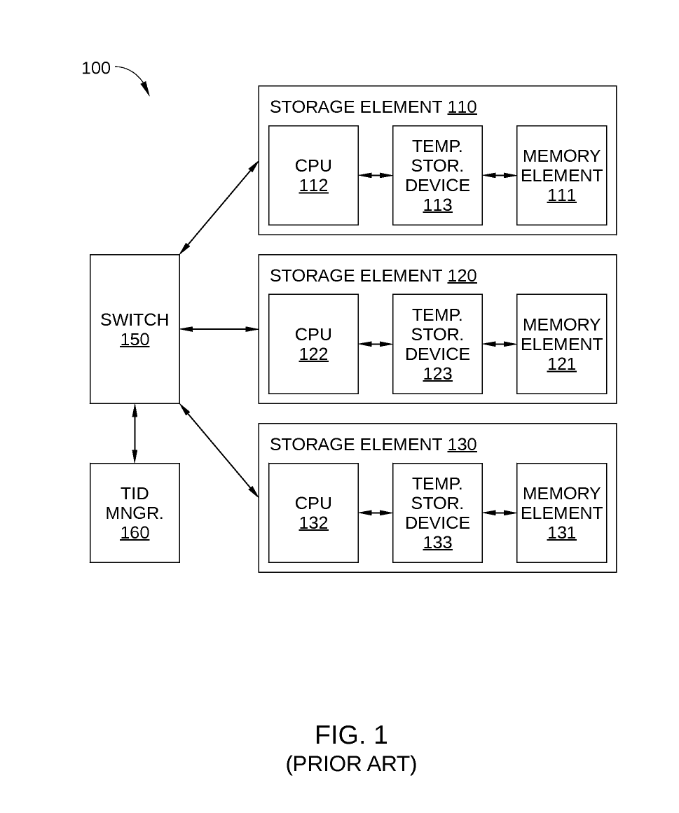

Conventional distributed computing systems generally include a plurality of memory elements (hard disk drives and/or SSDs) that are each controlled by a dedicated CPU or other processor. Such a configuration is inherently subject to network bottlenecks that can significantly increase system latency, as illustrated in FIG. 1. FIG. 1 schematically illustrates a portion of a conventional distributed computing system 100. Conventional distributed computing system 100 includes a plurality of storage elements 110, 120, and 130 that are communicatively coupled to each other through a network switch 150 to function as a single storage volume. For clarity, conventional distributed computing system 100 is illustrated with only three storage elements, but in practice, distributed storage and/or computing systems typically include many more than just three storage elements, for example dozens or hundreds, each of which may perform a different process or processes on data stored in conventional distributed computing system 100.

Storage element 110 includes a memory element 111, a CPU 112 for controlling access to memory element 111, and a temporary storage device 113 for CPU 112, such as a dynamic random-access memory (DRAM). Similarly, storage element 120 includes a memory element 121, a CPU 122 for controlling access to memory element 121, and a temporary storage device 123 for CPU 122, and storage element 130 includes a memory element 131, a CPU 132 for controlling access to memory element 131, and a temporary storage device 133 for CPU 132. In some configurations, CPUs 112, 122, and 132 may also be suitable for distributed computing applications, and may each be communicatively coupled to one or more clients or users.

In operation, a CPU of one storage element (e.g., CPU 112) may require access to data stored in a different storage element of conventional distributed computing system 100 (e.g., storage element 120). For example, a process running on CPU 112, or a client or user connected to or otherwise in communication with storage element 110, may require access to data stored throughout conventional distributed computing system 100. To access data residing in storage element 120, CPU 112 transmits a request to CPU 122 of storage element 120, and CPU 122 performs the requested operation, such as reading data from and/or writing data to memory element 121 of storage element 120. Thus, CPU 122 is responsible for implementing all requests for access to memory element 121, even when multiple CPUs in conventional distributed computing system 100 make such requests concurrently. Because access to each memory element of conventional distributed computing system 100 is controlled by a single dedicated CPU, consistency of data in each memory element is maintained.

Conventional distributed computing system 100 may include a transaction ID manager 160 that is coupled to network switch 150 and is configured to provide and track transaction IDs for each database transaction processed by conventional distributed computing system 100. Transaction IDs ensure that the multiple processes running on conventional distributed computing system 100 each process data in the correct order. Each database transaction is a unit of work performed within conventional distributed computing system 100 against data stored therein, and is treated in a coherent and reliable way independent of other transactions, i.e., each database transaction is atomic, consistent, isolated and durable. Specifically, the use of transaction IDs for database transactions in conventional distributed computing system 100 provides isolation between processes accessing conventional distributed computing system 100 concurrently. Without such isolation, a process running on one storage element may access and modify a data set prematurely, thereby resulting in erroneous output.

For example, a process running on CPU 122 of storage element 120 may be intended to process a data set stored in storage element 130 only after the data set is modified by a process running on CPU 112 of storage element 110. Transaction ID manager 160 can issue suitable transaction IDs for these two processes indicating the immediately preceding process for each data set accessed by each respective process. Specifically, the transaction ID for the process running on CPU 122 indicates that this process accesses and/or alters the data set stored in storage element 130 only after the preceding process (i.e., the process running on CPU 112) has completed access to that data set. In this way, data consistency and output accuracy in conventional distributed computing system 100 can be facilitated even though multiple concurrently running processes access and/or alter data stored in multiple locations in conventional distributed computing system 100.

However, in conventional distributed computing system 100, the computational resources of a particular storage element CPU can easily be overextended, resulting in increased system latency. For example, when multiple requests are made concurrently for access to a particular storage element, the CPU for that storage element generally processes each request serially, queuing all but one of the requests. Furthermore, besides controlling access to a particular memory element, the CPUs for each storage element in conventional distributed computing system 100 typically manage and/or process data stored locally in the associated memory element. Such activity can also increase system latency. In addition, network traffic between storage elements 110, 120, and 130 is generally routed through network switch 150; in configurations of conventional distributed computing system 100 that include a large number of storage elements, network switch 150 can be a significant network bottleneck that can increase system latency. Lastly, because each database transaction performed by conventional distributed computing system 100 generally requires a transaction ID issued by transaction ID manager 160, transaction ID manager 160 can be a significant network bottleneck that can increase system latency.

According to embodiments described herein, low-latency data processing is facilitated in a distributed computing system by avoiding network bottlenecks as described above. Specifically, memory elements of a distributed computing system are configured as a two-dimensional matrix of interconnected memory nodes, where one of the memory nodes is configured as a transaction ID manager.

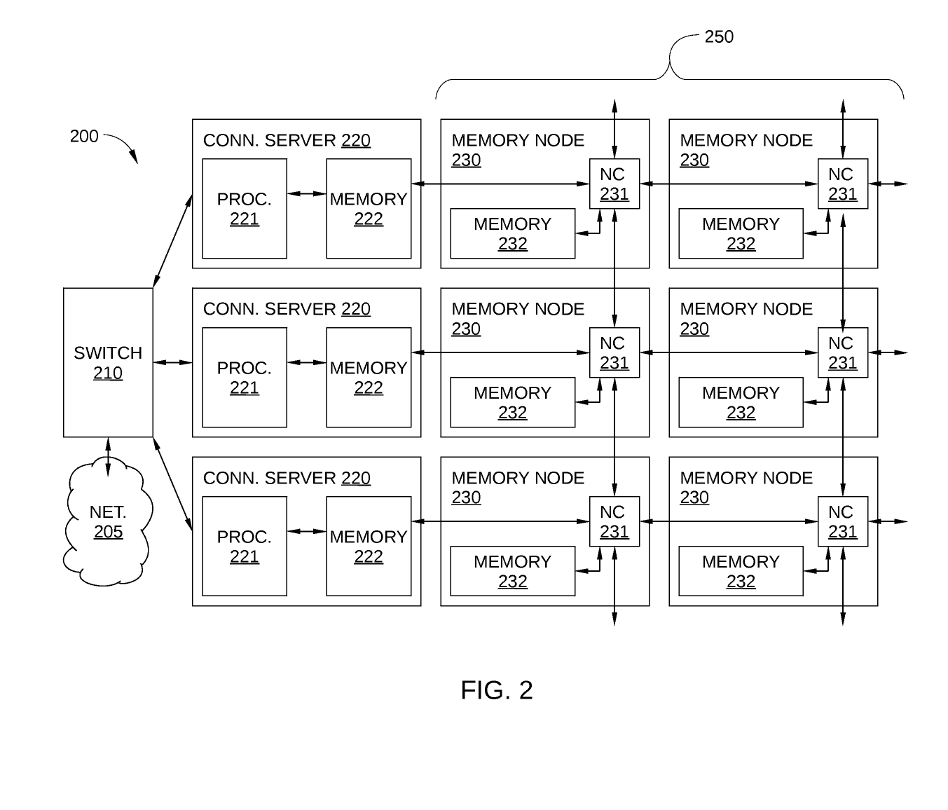

FIG. 2 schematically illustrates a portion of a distributed computing system 200, configured according to one embodiment. Distributed computing system 200 is suitable for use as any enterprise or large-scale data storage system, such as an on-line storage system (e.g., a file hosting service or cloud storage service) or an off-line backup storage system. Distributed computing system 200 includes a network switch 210, multiple connection servers 220, and a plurality of memory nodes 230, and may be configured as a rack-mounted (modular) server, or as a blade server. As shown, memory nodes 230 are arranged in an interconnected two-dimensional matrix 250, and are each configured with data-forwarding functionality, for example via packet forwarding. Consequently, any of connection servers 220 can access data from any of memory nodes 230 without routing a data request through another connection server 220.

Network switch 210 may be configured to connect distributed computing system 200 to an external network 205 and to route data traffic to and from distributed computing system 200. Network 205 may be any technically feasible type of communications network that allows data to be exchanged between distributed computing system 200 and external entities or devices, such as one or more clients. For example, network 205 may include a wide area network (WAN), a local area network (LAN), a wireless (WiFi) network, and/or the Internet, among others. As shown, each of connection servers 220 can be directly connected to network 205 via network switch 210.

Each connection server 220 is configured as an access point to two-dimensional matrix 250, and includes a processor 221 and a memory 222. In operation, each connection server 220 provides a connection point to distributed computing system 200 for a client or other entity external to distributed computing system 200, rather than managing access to a single memory node. Generally, processor 221 may be any technically feasible hardware unit capable of processing data and/or executing software applications for the operation of distributed computing system 200. For example, processor 221 may be implemented as a central processing unit (CPU), a graphics processing unit (GPU), an application-specific integrated circuit (ASIC), a field programmable gate array (FPGA), or other type of processing unit, or a combination of different processing units. Memory 222 is configured for use as a data buffer and/or as other temporary storage by processor 221. Memory 222 may be any suitable memory device, and is coupled to CPU 221 to facilitate operation of CPU 221. In some embodiments, memory 222 is includes one or more volatile solid-state memory devices, such as one or more dynamic RAM (DRAM) chips. In some embodiments, each connection server 220 is implemented as an individual module or card that is mounted on a motherboard.

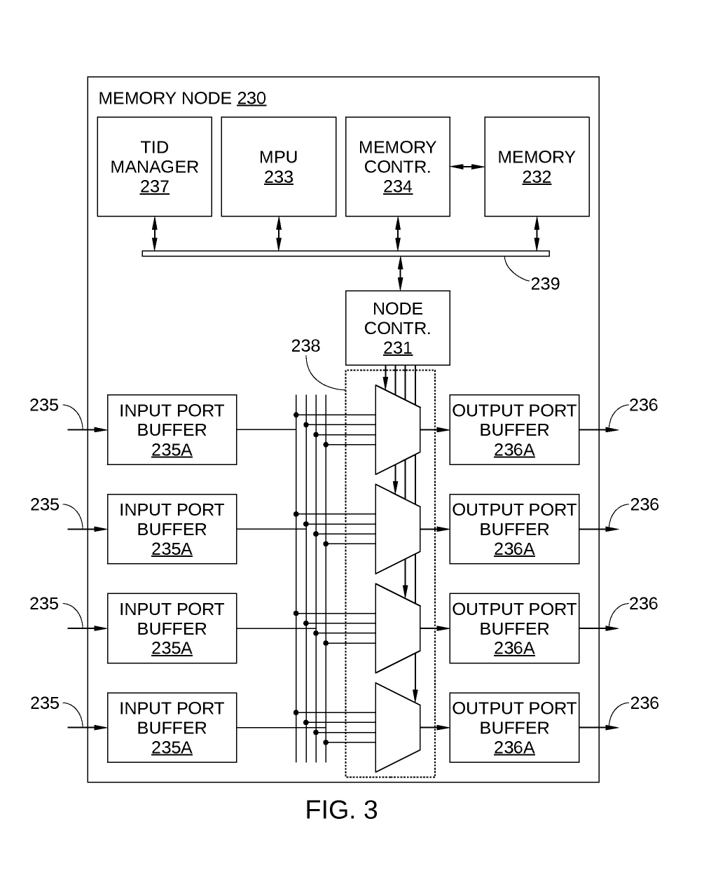

Each memory node 230 is configured as a data storage element of distributed computing system 200, and is communicatively coupled as shown to adjacent memory nodes 230 of two-dimensional matrix 250 through input and output ports (described below in conjunction with FIG. 3). In addition, each memory node includes a node controller 231 and a non-volatile memory 232. Node controller 231 is configured to route information, such as data packets, to and from adjacent memory nodes 230 in distributed computing system 200 and to non-volatile memory 232. In some embodiments, node controller 231 is implemented as logical circuitry, for example a field-programmable gate array (FPGA) or an application-specific integrated circuit (ASIC), to reduce latency of operations associated therewith. Non-volatile memory 232 may include one or more solid-state memory devices, such as a NAND flash chip or other flash memory device. In some embodiments, each memory node 230 is implemented as an individual module or card that is mounted on a motherboard or other printed circuit board, along with connection servers 220. One embodiment of a memory node 230 is described in greater detail in conjunction with FIG. 3.

FIG. 3 schematically illustrates a memory node 230 of distributed computing system 200, according to an embodiment. As shown, memory node 230 includes node controller 231, non-volatile memory 232, a microprocessing unit (MPU) 233, a memory controller 234, four input ports 235 and associated input port buffers 235A, four output ports 236 and associated output port buffers 236A, a packet selector 238, and a local bus 239. In some embodiments, one, and in other embodiments all, of memory nodes 230 of distributed computing system 200 include a transaction ID (TID) manager 237. In some embodiments, MPU 233, memory controller 234, TID manager 237, and packet selector 238 are implemented as logical circuitry, for example as one or more FPGAs or ASICs, to reduce latency of operations associated therewith.

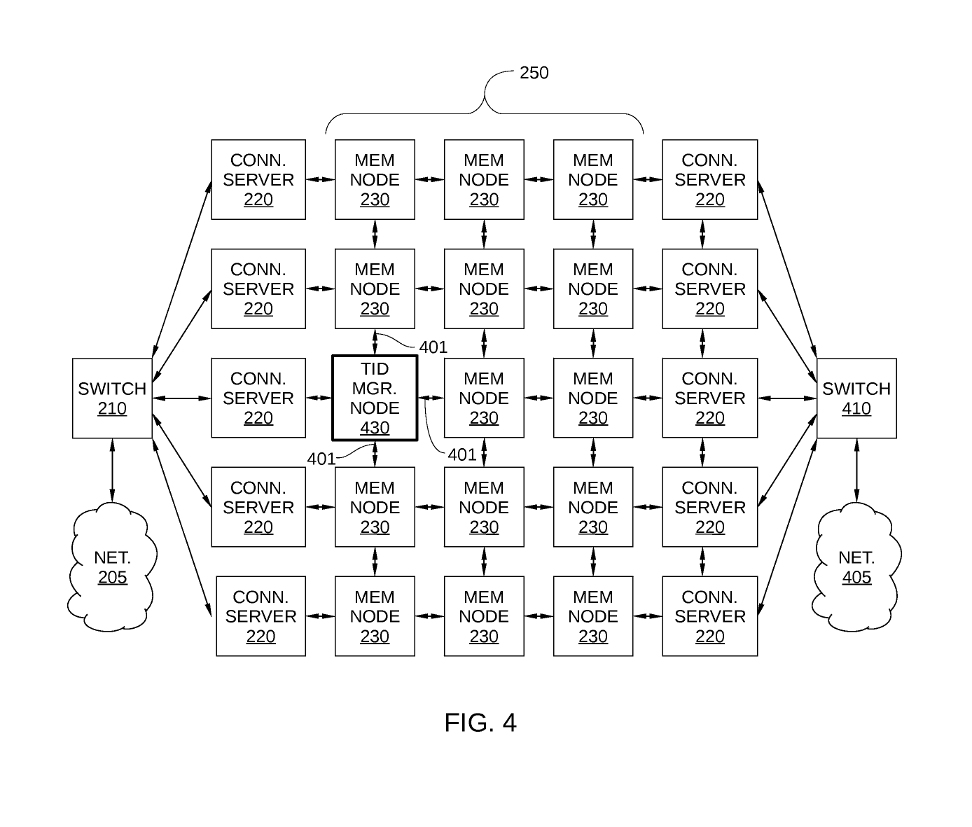

MPU 233 is configured to perform arithmetic processing during operation of memory node 230, and memory controller 234 is configured to control write, read, and erase operations with respect to non-volatile memory 232. Local bus 239 is configured to mutually connect input port buffers 235A, node controller 231, memory controller 234, TID manager 237, and MPU 233 for facilitating signal transmission to and from adjacent memory nodes 230. TID manager 237 is configured to generate a TID for a connection server 220 that requests a database transaction, such as reading from or writing to a memory node 230. Each TID is a unique, sequentially issued number, and is determined according to a multi-version concurrency control (MVCC) scheme. MVCC is a concurrency control method commonly used by database management systems to provide concurrent access to the database and in programming languages to implement transactional memory. One such MVCC scheme is described below in conjunction with FIG. 4.

Node controller 231 is configured to route data to and from adjacent memory nodes 230 of distributed computing system 200. In some embodiments, two-dimensional matrix 250 of memory nodes 230 is configured as a packet-switched network, and node controller 231 uses packet forwarding to route data. As used herein, a data packet includes a formatted unit of transferring data that is carried by a packet-switched network and includes a header portion with a destination (target) address, a source address, and a data portion. In such embodiments, node controller 231 of a first memory node 230 of distributed computing system 200 may be configured to route data packets to a second memory node 230 of distributed computing system 200 when the data packets are associated with a data request for data stored in the second memory node 230, i.e., when the destination address of the data packets corresponds to the second memory node 230. Similarly, the node controller 231 of the first memory node 230 may be configured to route data packets to a requesting connection server 220 of distributed computing system 200 when the data packets include data requested by the connection server 220, i.e., when the destination address of the data packets corresponds to the requesting connection server 220. In some embodiments, node controller 231 routes data packets received via input ports 235 to an appropriate output port 236 based on a position coordinate or address of the destination memory node 230. In other embodiments, any other suitable routing algorithm may be used by node controller 231 to route data packets.

In operation, memory node 230 receives a data packet through one of input ports 235 and temporarily stores the data packet in the input port buffer 235A that corresponds to the receiving input port 235. Node controller 231 then determines whether the received data packet is addressed to the receiving memory node 230 (hereinafter referred to as the “local node”) based on the destination address of the data packet and the address of the local node. If the received data packet is addressed to the local node, then node controller 231 performs the write or read operation in non-volatile memory 232 of the local node. If the received packet is not addressed to the local node, then node controller 231 determines to which adjacent memory node 230 the data packet should be forwarded based on the destination address of the data packet and the address of the local node, and inputs a suitable control signal to packet selector 238. Packet selector 238 receives the data packet from the input buffer 235A storing the data packet, and outputs the data packet to the appropriate output port buffer 236A in response to the control signal received from node controller 231. In this case, the appropriate output port buffer 236A is associated with the output port 236 corresponding to the adjacent memory node 230 that node controller 231 has determined the data packet should be forwarded to. The output port buffer 236A temporarily stores the data packet output from packet selector 238 and outputs the data packet to the output port 236 corresponding to the appropriate adjacent memory node 230. The adjacent memory node 230 then performs the above procedure with respect to the data packet as the local node.

As described above, each memory node 230 of distributed computing system 200 is configured with data-forwarding functionality, so that a particular connection server 220 can access data from any other memory nodes 230 without routing a data request through another connection server 220. Consequently, network bottlenecks can be avoided and system latency reduced in distributed computing system 200. To facilitate the above-described architecture, in some embodiments, one of memory nodes 230 is configured as transaction ID manager 237. Transaction ID manager 237 regulates concurrency of database transactions performed in distributed computing system 200 by issuing a transaction ID for each database transaction. Such transaction IDs can be configured to provide isolation between the multiple processes that may be running in distributed computing system 200 and accessing data stored therein. One such embodiment is illustrated in FIG. 4.

FIG. 4 schematically illustrates a distributed computing system 400, configured according to one embodiment. Distributed computing system 400 may be substantially similar to distributed computing system 200 in FIG. 2, and includes network switch 210, multiple connection servers 220, and a plurality of memory nodes 230 arranged in interconnected two-dimensional matrix 250. In addition, distributed computing system 400 may include a second network switch 410, which facilitates connection of distributed computing system 400 to a second network 405 (e.g., network 205 may be a LAN and second network 405 may be the Internet). In addition, distributed computing system 400 includes a TID manager node 430.

TID manager node 430 may include the functionality of a memory node 230 and of a TID manager configured to manage concurrency of database transactions performed in distributed computing system 200. Requests for TIDs can be received from other memory nodes 230 without going through switch 210 or switch 410, and TIDs can be sent to other memory nodes 230 via multiple network paths 401 without going through switch 210 or switch 410. Consequently, network bottlenecks in distributed computing system 400 are significantly reduced.

In some embodiments, TID manager node 430 employs an MVCC scheme to provide concurrent access to data stored in distributed computing system 400 by multiple processes. The MVCC scheme may be substantially similar in implementation to MVCC schemes known in the art, except that the entity employing the MVCC scheme (i.e., TID manager node 430) is included in one of memory nodes 230, and is not a separate TID manager module coupled to multiple memory nodes via a single network switch.

MVCC schemes allow multiple applications, users, or processes (hereinafter referred to as “processes”) to access a particular file or data object (hereinafter referred to as an “object”) stored in distributed computing system 400. Each process accesses a particular “snapshot” of the object at a particular instant in time. Thus, any changes made by a process modifying the object (for example, via a write command) cannot be accessed by other processes (such as other users of distributed computing system 400) until the changes have been completed by the modifying process (i.e., until the database transaction corresponding to the process of modifying the object has completed). In this way, an older, unmodified version of the object is still available to other read processes while the object is being modified by a write process. Consequently, there may be multiple versions of a particular object stored in distributed computing system 400, but only one version of the object is the latest version and available for modification. This allows a read process to access a static version of an object, even when the object is modified or deleted by a different process during the period of time that the read process is accessing the object. MVCC schemes generally employ a TID (a unique sequential ID number, for example a number including a timestamp) to indicate which state or version of an object stored in distributed computing system 400 a particular process accesses.

In some embodiments, each of memory nodes 230 may include the functionality of a TID manager configured to manage concurrency of database transactions performed in distributed computing system 200. In this way, the TID manager functionality is distributed throughout two-dimensional matrix 250. Unlike distributed computing system 400, there is not a single TID manager (i.e., TID manager node 430), and network bottlenecks are further reduced. This is because network traffic in such a distributed computing system is generally between a requesting connection server 220 and a target memory node 230. In contrast, in distributed computing system 400, there is initially network traffic between the single TID manager node 430 and the requesting connection server 220, then there is network traffic between the requesting connection server 220 and the target memory node 230. Thus, each database transaction executed in distributed computing system 400 also includes communications to and from TID manager node 430.

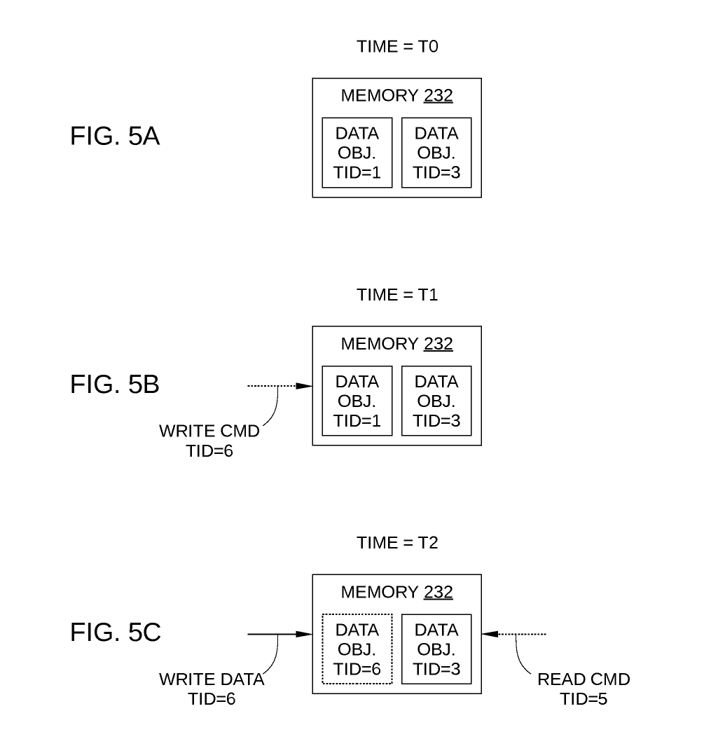

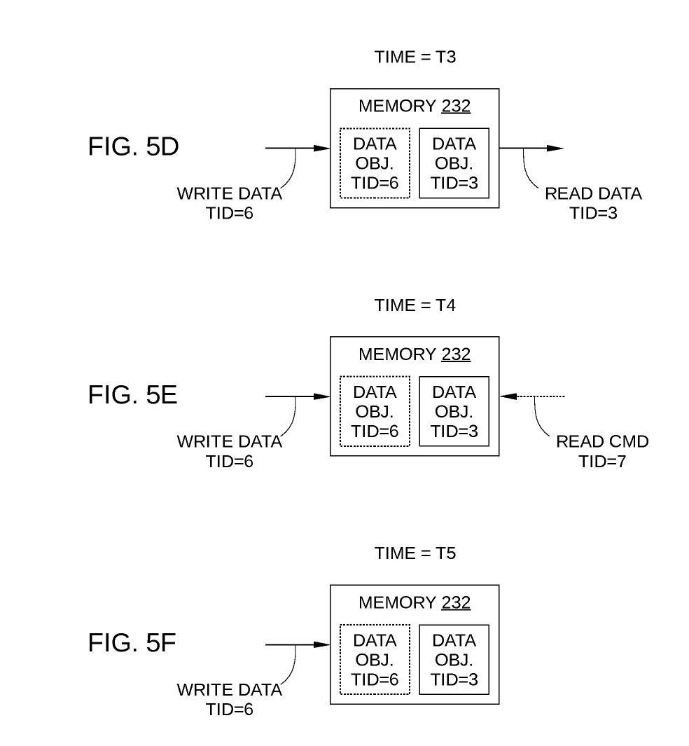

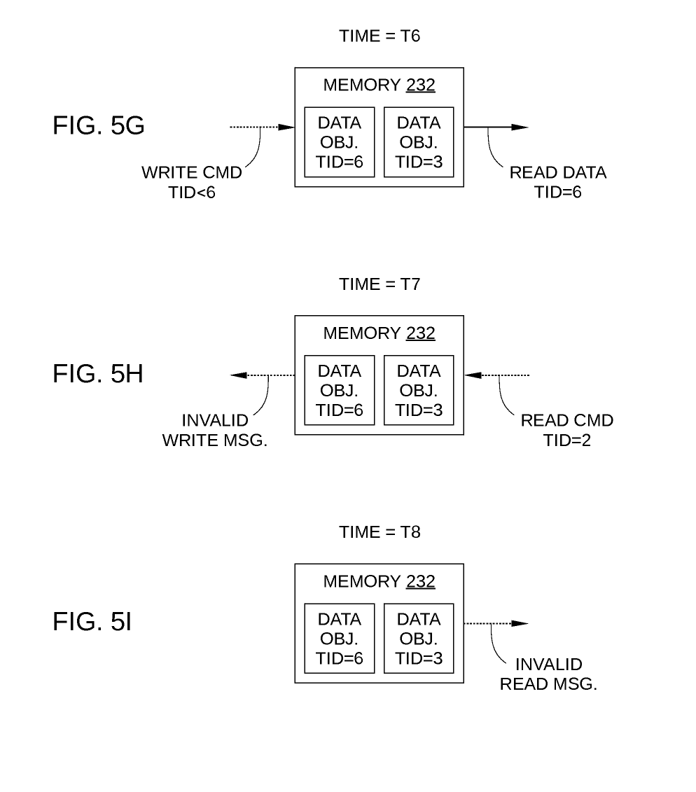

FIGS. 5A-5I schematically illustrate the use of TIDs at a memory node 230 in an MVCC scheme that may be implemented in a distributed computing system, according to some embodiments. Specifically, FIGS. 5A-5I depict a particular memory 232 of a memory node 230 at times T0-T8, respectively. The MVCC herein described may be employed by TID manager node 430 in FIG. 4 or by each of memory nodes 230 in FIG. 2 when each memory node is configured as a TID manager node.

In embodiments in which a distributed computing system is configured with a single TID manager node (e.g., TID manager node 430 in distributed computing system 400), the single TID manager node issues TIDs for the write commands and read commands described in conjunction with FIGS. 5A-5I. In embodiments in which each memory node of a distributed computing system is configured as a TID manager node, the memory node 230 associated with the memory 232 in FIGS. 5A-5I receiving write commands and read commands issues TIDs for these write commands and read commands independently with respect to other TID managers in distributed computing system 200. In such embodiments, each TID issued by the memory node 230 includes a unique sequential number for managing transactions received by the memory node 230, and is transmitted with a node ID of the memory node 230 that issued the TID. Consequently, the TIDs issued by one memory node 230 of a distributed computing system are distinguished from the TIDs issued by any other memory nodes 230 of the distributed computing system, since each TID has associated therewith a node ID of the memory node 230 that generated the TID.

At time T0, as shown in FIG. 5A, memory 232 includes two versions of a data object, one associated with TID=1 (hereinafter referred to as Data Object 1) and another, later version of the same data object associated with TID=3 (hereinafter referred to as Data Object 3). For example, Data Object 1 may be stored in memory 232 via a write command having a TID=1, and Data Object 3 may be stored in memory 232 via a write command having a TID=3. Because TIDs are issued by a single TID manager sequentially, Data Object 3 is a later version of the data object than Data Object 1. In the embodiment illustrated in FIG. 5A, memory 232 retains the two most recent versions of the same data object, but in other embodiments, memory 232 may be configured to store more than two versions of the same data object, e.g., the most recent five or ten versions of the data object. In either case, it is noted that multiple versions of a particular data object are associated with (i.e., “stored at”) a particular memory address. It should be understood that each of these multiple versions is actually stored in a different physical location in memory 232, but is mapped to the same memory address. Association of each version of a data object with a TID may be used to differentiate these multiple versions from each other, as illustrated below.

FIG. 5B illustrates memory 232 at time T1, when memory 232 receives a write command with a TID=6. The TID for this write command was issued by the memory node 230 that includes memory 232 and in response to a write request from the connection server 220 that subsequently transmitted the write command shown in FIG. 5B. The write command may be received from any of connection servers 220 of the distributed computing system, and is typically so received after being routed through two-dimensional matrix 250 of memory nodes. Hence, memory 232 generally receives the write request from a memory node adjacent to the memory node that includes memory 232. The write command may include data to be written, the TID issued for the write command, and a memory address to which the data is to be written in memory node 232.

The memory node 230 that includes memory 232 then determines whether the write command received at time Ti is valid with respect to the versions of the data object stored in memory 232. For example, in some embodiments, memory node 230 compares the sequential number of the transaction ID (e.g., TID=6) to a corresponding sequential number of the TID associated with data stored at the memory address (TID=3 and TID=1). Generally, the most recent version of the data object is used for such a comparison (i.e., TID=3). Because the TID of the received write command is greater than the TID of the most recent version of the data object (6 >3), memory node 230 considers the write command to be valid, accepts the write command, and begins writing data to memory 232. If on the other hand the TID of the received write command is less than the TID of any of the versions of the data object in question, memory node 230 considers the write command to be invalid, as described below.

FIG. 5C illustrates memory 232 at time T2, when memory 232 begins execution of the write command received at time T1. In the embodiment illustrated in FIG. 5C, the oldest version of the data object (i.e., Data Object 1) is replaced in memory 232 by execution of the write command (i.e., Data Object 6). Because the write command is incomplete, Data Object 6 is not available to any other processes.

In addition to beginning execution of the write command received at time T1, at time T2, the memory node 230 that includes memory 232 receives a read command (TID=5) for the data object stored in memory 232, for example from one of the connection servers 220. This read command may include the TID issued for the read command and a memory address from which the data are to be read in memory node 232. In embodiments in which each memory node 230 of a distributed computing system is configured as a TID manager node, the memory node 230 that includes memory 232 issues the TID for the read command, and the address from which data is to be read corresponds to the memory node 230 that generated the transaction ID for the read command. Because the TID of the read command (TID=5) is greater than the TID (TID=3) associated with most recent accessible version of the data object (Data Object 3), Data Object 3 is available to be read by the read command received at time T2.

FIG. 5D illustrates memory 232 at time T3, when execution of the write command received at time T1 continues. The read command received at time T2 is also executed, and read data (from Data Object 3) are routed to the connection server 230 that issued the read command, as shown. By way of illustration, the write command received at time T1 and the read command received at time T2 are depicted as being executed simultaneously, however, in some embodiments, read and write commands are executed sequentially. Thus, in FIG. 5D, the write command received at time T1 may first be completed, then the read command received at time T2 may be completed.

FIG. 5E illustrates memory 232 at time T4, when memory 232 receives another read command (TID=7) while the write command received at time T1 is still being executed. The TID of the read command (TID=7) is greater than the TID associated with Data Object 6 (TID=6), which is the most recent version of the data object in memory 232. Because Data Object 6 is not yet available to be read, memory 232 blocks this read command until Data Object 6 is written, and the data associated therewith can be read.

FIG. 5F illustrates memory 232 at time T5, while the write command received at time T1 is still being executed. The read command received at time T4 pauses until Data Object 6 is written and is available for reading.

FIG. 5G illustrates memory 232 at time T6, when the writing of Data Object 6 is complete. Consequently, the read command received at time T4 is executed, and read data associated with Data Object 6 is routed to the connection server that issued the read command received at time T4. At time T6, the memory node 230 that includes memory 232 also receives another write command (TID<6).

FIG. 5H illustrates memory 232 at time T7, when the memory node 230 that includes memory 232 determines that the write command received at time T6 is invalid with respect to data stored at the memory address included in the write command. For example, in some embodiments, the memory node 230 compares the sequential number of the transaction ID (TID<6) to a corresponding sequential number of the TID (TID=6) associated with data stored at the memory address included in the write request to determine validity of the write command. Because the TID of the write command (TID<6) is less than the TID associated with the most recent version of the data object stored at the memory address (Data Object 6, TID=6), the write command is considered invalid, and the memory node 230 sends an error message (e.g., an invalid write command message) to the connection server 220 that issued the write command received at time T6. Generally, network latency and the relative position of memory 232 to the various connection servers 220 may cause a write command with a TID<6 to be received out of order at memory node 230, for example after a write command with a TID=6. At time T7, the memory node 230 that includes memory 232 also receives a read command (TID=2) for the data object stored in memory 232.

FIG. 51 illustrates memory 232 at time T8, when the memory node 230 that includes memory 232 determines that the read command received at time T7 is invalid with respect to data stored at the memory address included in the write command. For example, in some embodiments, the memory node 230 compares the sequential number of the transaction ID of the read command (TID=2) to a corresponding sequential number of the TID associated with the oldest version of data stored at the memory address included in the read request (TID=3). Because the TID of the read command (TID=2) is less than the TID associated with the oldest accessible version of the data object (TID=3 for Data Object 3), the read command is considered invalid, and the memory node 230 sends an error message (e.g., an invalid read command message) to the connection server 220 that issued the read command received at time T7

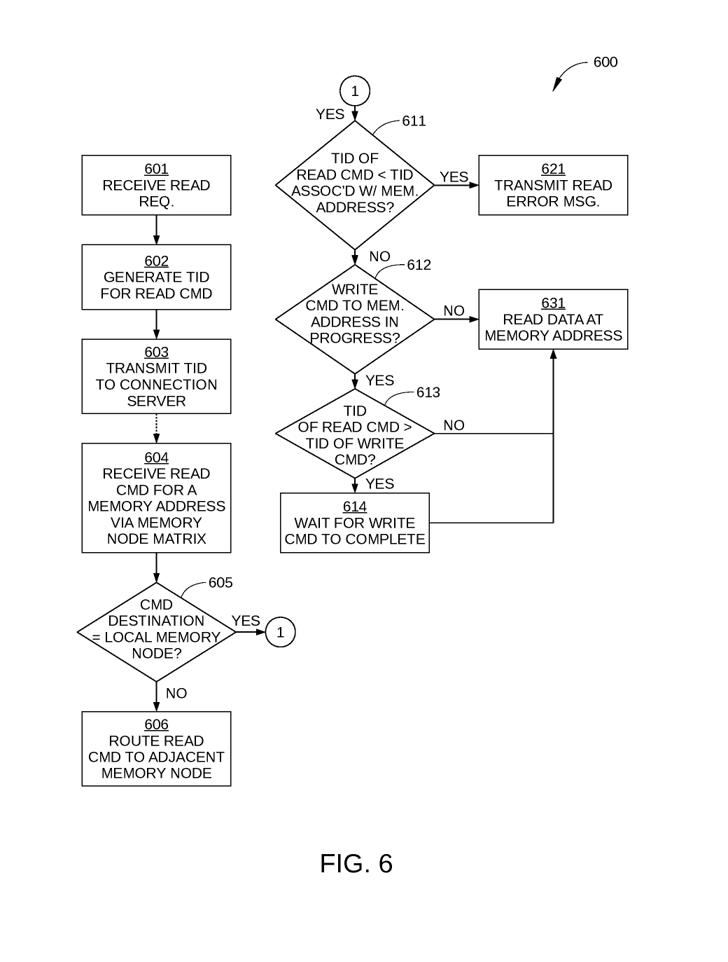

FIG. 6 sets forth a flowchart of method steps for processing a read request carried out by a memory node 230 when configured with the functionality of a TID manager, according to some embodiments. Although the method steps are described in conjunction with distributed computing system 200 of FIG. 2, persons skilled in the art will understand that the method in FIG. 6 may also be performed with other types of computing systems.

As shown, method 600 begins at step 601, where a memory node 230 of distributed computing system 200 receives a read request for a memory address associated with the memory node. The read request is received from one of the connection servers 220, which are configured to transmit such a request for a transaction ID to the memory node 230 prior to issuing an IO command (e.g., a read command or a write command) that includes the transaction ID in the IO command. The read request may be received directly from the connection server 220 when memory node 230 happens to be adjacent to the requesting connection server 220. Otherwise, the read request is typically received from the connection server 220 via one or more intervening memory nodes 230, which are configured to route such communications to the target memory node.

In step 602, the memory node 230 generates a TID for the read command, for example using TID manager 237. In step 603, memory node 230 transmits the TID generated in step 602 to the requesting connection server 220. In embodiments in which each memory node 230 of distributed computing system 200 includes a TID manager 237, a local memory node ID is transmitted with the TID generated in step 602 to distinguish this TID from TIDs generated by other memory nodes 230.

In step 604, memory node 230 receives a read command from a connection server 220. The read command is generally for a particular memory address in distributed computing system 200 and includes the TID issued to the connection server and the memory address from which data is to be read. In some embodiments, to distinguish which memory node 230 of distributed computing system 200 is the target memory node, the memory address includes an ID of the target memory node 230. In other embodiments, the target memory node 230 of the read command can be inherently distinguished based on the particular memory address included in the read command, since each memory address associated with distributed computing system 200 is mapped to a single memory node 230. As with the read request, the read command is typically received via one or more memory nodes 230 of two-dimensional matrix 250.

In step 605, memory node 230 determines whether the destination of the read command received in step 604 is the receiving (local) memory node. If yes, method 600 proceeds to step 611. If no, method 600 proceeds to step 606. In step 606, the read command is routed to an adjacent memory node based on the location of the target memory node 230.

In step 611, memory node 230 determines whether the TID associated with the read command is less than the TID associated with the oldest version of data stored at the memory address from which data are to be read. If no, method 600 proceeds to step 612. If yes, then the TID of the read command was issued before any of the versions of data stored at the memory address were written. Consequently, there is no version of data available that corresponds to the time when the read command was issued, and the read command is considered invalid. Method 600 therefore proceeds to step 621, in which memory node 230 transmits an error message, such as an invalid read command message, to the connection server 220 that issued the read command.

In step 612, memory node 230 determines if a write command or other modification associated with the memory address included in the read command is in progress. If yes, method 600 proceeds to step 613. If no, then method 600 proceeds to step 631, and data are read from the memory address in the read command. In some embodiments, the most recent version of data stored at the memory address that is not associated with a TID that is greater than the TID of the read command, and consequently a previous version of the data, is read, rather that the most recent version of data. The data read in step 631 are then transmitted via two-dimensional matrix 250 to the connection server 220 that issued the read command.

In step 613, memory node 230 determines whether the TID of the read command is greater than the TID of the write command currently in progress and associated with the memory address included in the read command. If no, then a previous version of data stored at the memory address should be read, and method 600 proceeds to step 631. If yes, then method 600 proceeds to step 614. In step 614, memory node 230 pauses the read command by waiting until the above-described write command is completed. Method 600 then proceeds to step 631, in which the version of data written as a result of the above-described write command is read and transmitted to the connection server 220 that issued the read command.

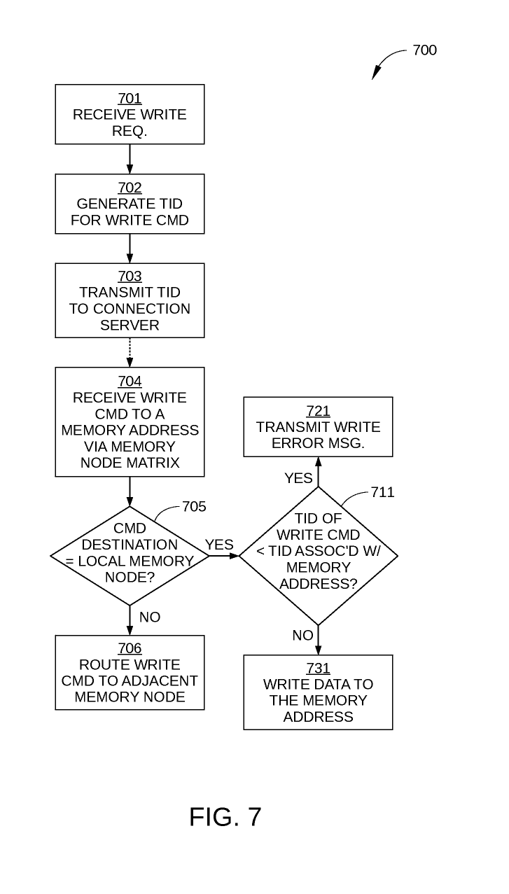

FIG. 7 sets forth a flowchart of method steps for processing a write request carried out by a memory node 230 when configured with the functionality of a TID manager, according to some embodiments. Although the method steps are described in conjunction with distributed computing system 200 of FIG. 2, persons skilled in the art will understand that the method in FIG. 7 may also be performed with other types of computing systems.

As shown, method 700 begins at step 701, where a memory node 230 of distributed computing system 200 receives a write request for a memory address associated with memory node 230. The write request is received from one of the connection servers 220, which is configured to transmit such a request for a transaction ID to memory node 230 prior to issuing an IO command that includes the transaction ID in the IO command. The write request may be received directly from the connection server 220 when memory node 230 happens to be adjacent to the requesting connection server 220. Otherwise, the write request is typically received from the connection server 220 via one or more intervening memory nodes 230, which are configured to route such communications to the target memory node.

In step 702, the memory node 230 generates a TID for the write command, for example using TID manager 237. In step 703, memory node 230 transmits the TID generated in step 702 to the requesting connection server 220. In embodiments in which each memory node 230 of distributed computing system 200 includes a TID manager 237, a local memory node ID is transmitted with the TID generated in step 702 to distinguish this TID from TIDs generated by other memory nodes 230.

In step 704, memory node 230 receives a write command from a connection server 220. The write command is generally for a particular memory address in distributed computing system 200 and includes the TID issued to connection server 220 and the memory address to which data are to be written. In some embodiments, to distinguish which memory node 230 of distributed computing system 200 is the target memory node, the memory address includes an ID of the target memory node 230. In other embodiments, the target memory node 230 of the write command can be inherently distinguished based on the particular memory address included in the write command, since each memory address associated with distributed computing system 200 is mapped to a single memory node 230. As with the write request, the write command is typically received via one or more memory nodes 230 of two-dimensional matrix 250.

In step 705, memory node 230 determines whether the destination of the write command received in step 704 is the receiving (local) memory node. If yes, method 700 proceeds to step 711. If no, method 700 proceeds to step 706. In step 706, the write command is routed to an adjacent memory node based on the location of the target memory node 230.

In step 711, memory node 230 determines whether the TID associated with the write command is less than the TID associated with any version of data stored at the memory address to which data are to be written. If no, method 700 proceeds to step 731. If yes, then the TID of the write command was issued before at least one of the versions of data stored at the memory address were written. Consequently, execution of the write command would result in an older version of data to be the most recently stored at a memory address, which is highly undesirable in terms of data concurrency. Thus, the write command is considered invalid, and method 700 proceeds to step 721, in which memory node 230 transmits an error message, such as an invalid write command message, to the connection server 220 that issued the write command.

In step 731, data are written to the memory address included in the write command. In some embodiments, the oldest version of data stored at the memory address (based on a TID associated with the stored version) is replaced in memory 232 by the version of the data written to memory 232 as a result of the write command.

While the foregoing is directed to embodiments of the present invention, other and further embodiments of the invention may be devised without departing from the basic scope thereof, and the scope thereof is determined by the claims that follow.

We claim:

1. A memory system comprising:
a plurality of memory nodes interconnected with each other; and
at least one connection server having an interface to a network switch and connected to the memory nodes,
wherein each of the memory nodes includes a non-volatile memory device and a node controller configured to communicate with node controllers of other nodes, and the node controller of at least one of the memory nodes includes a transaction ID generator configured to generate a unique transaction ID in response to a request for a transaction ID received from the connection server.

2. The memory system of claim 1, wherein the connection server is configured to transmit the request for the transaction ID to one of the plurality of memory nodes prior to issuing an IO command that includes the transaction ID in the IO command.

3. The memory system of claim 2, wherein the IO command includes one of a read command including an address from which data is to be read and a write command including data to be written and an address to which the data is to be written.

4. The memory system of claim 2, wherein each of the plurality of memory nodes includes a transaction ID generator configured to generate a unique transaction ID, independently with respect to other transaction ID generators, in response to the request for a transaction ID received from the connection server.

5. The memory system of claim 4, wherein the address from which data is to be read corresponds to the memory node that includes the transaction ID generator that generated the unique transaction ID and the address to which data is to be written corresponds to the memory node that includes the transaction ID generator that generated the unique transaction ID.

6. The memory system of claim 1, further comprising an additional connection server having an interface to the network switch and connected to the memory nodes.

7. The memory system of claim 6, wherein transaction ID generator is further configured to generate a unique transaction ID in response to a request for a transaction ID received from the additional connection server.

8. The memory system of claim 1, wherein the unique transaction ID comprises a sequentially issued number.

9. The memory system of claim 1, wherein each of the plurality of memory nodes includes a transaction ID generator configured to generate a unique transaction ID in response to the request for a transaction ID received from the connection server and the unique transaction ID comprises a sequentially issued number and a node ID of the memory node.

10. A method of processing a read request at a target memory node of a data storage device that includes at least one connection server and a plurality of memory nodes, including the target memory node, interconnected with each other and connected to the at least one connection server, the method comprising:
receiving a read command from a connection server that includes a transaction ID, an ID of a memory node, and a memory address from which data is to be read;
reading data stored at the memory address from the target memory node, if an ID of the target memory node matches the ID of the memory node included in the read command and a transaction ID associated with data stored in the memory address is less than the transaction ID included in the read command; and
transmitting from the target memory node to the connection server the data read from the memory address.

11. The method of claim 10, further comprising, if the transaction ID associated with data stored in the memory address is greater than the transaction ID included in the read command, determining that the read command is invalid with respect to data stored at the memory address.

12. The method of claim 10, further comprising determining whether a write command that includes the memory address is currently in progress and, if so, wherein reading data stored at the memory address comprises:
pausing the read command until the write command is completed; and
reading data that are stored at the memory address and have been written as a result of the write command.

13. The method of claim 10, further comprising, if the ID of the target memory node does not match the ID of the memory node included in the read command, routing the read command to a memory node that is adjacent to the target memory node.

14. The method of claim 10, wherein transmitting from the target memory node to the connection server the data read from the memory address comprises routing the data to the connection server via one or more of the plurality of memory nodes.

15. The method of claim 10, further comprising,
receiving a second read command, wherein the second read command is received from an additional connection server and includes a second transaction ID, a second ID of a memory node, and a second memory address from which data is to be read;
reading data stored at the second memory address from the target memory node, if an ID of the target memory node matches the second ID of the memory node and a transaction ID associated with data stored in the second memory address is less than the second transaction ID; and
transmitting from the target memory node to the additional connection server the data read from the second memory address.

16. A method of processing a write request at a target memory node of a data storage device that includes at least one connection server and a plurality of memory nodes, including the target memory node, interconnected with each other and connected to the at least one connection server, the method comprising:
receiving a write command from a connection server that includes data to be written, a transaction ID, an ID of a memory node, and a memory address to which the data are to be written; and
writing the data in the memory address, if an ID of the target memory node matches the ID of the memory node included in the write command and a transaction ID associated with data most recently stored in the memory address is less than the transaction ID included in the write command.

17. The method of claim 16, further comprising, if the transaction ID associated with data most recently stored in the memory address is greater than the transaction ID included in the write command, determining that the write command is invalid with respect to data stored at the memory address.

18. The method of claim 16, further comprising, if the ID of the target memory node does not match the ID of the memory node included in the write command, routing the write command to a memory node that is adjacent to the target memory node.

19. The method of claim 16, wherein writing the data in the memory address comprises replacing an oldest version of data stored in the target memory node at the memory address.

20. The method of claim 16, wherein receiving the write command from the connection server comprises receiving the write command routed from a memory node adjacent to the memory node receiving the write command.
